(19) United States
(12) Patent Application Publication
(10) Pub. No.: US 2010/0146546 A1
(43) Pub. Date: Jun. 10, 2010

(54) ELECTRONIC PROGRAM GUIDE FOR MOBILE NAVIGATION DEVICE, DESTINATION INFORMATION PROVIDING METHOD, AND DEVICE

(75) Inventors: Akitaka Nishimura, Tokyo (JP); Masakatsu Yoneda, Tokyo (JP); Masahiko Saito, Tokyo (JP); Asahi Iwanaga, Tokyo (JP); Akio Yoshimoto, Kanazawa (JP)

Correspondence Address: ROPES & GRAY LLP, PATENT DOCKETING 39/41, ONE INTERNATIONAL PLACE, BOSTON, MA, 02110-2624, US

(73) Assignee: United Video Properties, Inc., Los Angeles, CA (US)

(21) Appl. No.: 12/448,708

(22) PCT Filed: Jan. 7, 2008
(86) PCT No.: PCT/JP2008/050042

§ 371 Date: Jan. 12, 2010

(30) Foreign Application Priority Data
Feb. 5, 2007 (JP) 2007-000759

(51) Int. Cl. H04N 5/445; H04N 7/173

(52) U.S. Cl. 725/39; 725/133

(57) ABSTRACT

Provided is a method for providing target information related to a medium program. The method includes: a step that a user medium device receives a medium program containing destination information related to the medium program; a step that the user medium device extracts the destination information from the received medium program; a step that the user medium device transmits at least a part of the extracted destination information so that a user position identification device further performs processing on it; and a step that the user position identification device processes at least a part of the transmitted destination information.

### DETAILED DESCRIPTION OF THE INVENTION

1. Technical Field

The present invention provides an electronic program guide, mobile navigation method and system whereby an electronic program guide is installed in a mobile navigation device, so that various functions and detailed information of the electronic program guide can be fully utilized to achieve the identification of and navigation to a destination through a more reliable and simple operation.

2. Background Art

Navigation systems that utilize the GPS and devices that permit television broadcasts to be received and viewed on a mobile telephone have been proposed, so the opportunities for viewing television programming in cars or outside are increasing. The electronic program guide (EPG) has become essential as a guide tool for viewing the television broadcasts, and car navigation systems and mobile phones equipped with the EPG are known. With the electronic program guide, a program guide for television broadcasts is displayed on a screen, which makes it possible to easily determine what programs are broadcast and on which channel and at what time they are broadcast even without a newspaper or magazine. Moreover, it is also possible to find out programming information about those programs. As television receivers are installed in mobile terminal devices, electronic program guides (EPG) are also incorporated, so that the selection of television programs, recording of programs and scheduled recording can be simply performed from the EPG outdoors.

An idea of incorporating the electronic program guide into the mobile terminals and a method of selecting television programming content information through the mobile terminals have been proposed (e.g., see Patent Reference 1).

[Patent Reference 1] Japanese Laid-Open. Publication No. 2001-33044

### DISCLOSURE OF THE INVENTION

### Problems to be Solved by the Invention

However, although many proposals have been made in the past regarding methods for implementing EPG functions, such as searching and recording of television programs, in the mobile terminals, no proposal has been made regarding a method in connection with a navigation system for setting a spot, which is introduced in a television program, as a destination to be guided into the navigation system or the like in a simple manner.

Recently, travel, sightseeing and local information is often provided in television programs, and it is strongly desired to set restaurants, hotels or other locations introduced in such television programs as a destination in car navigation systems.

In this case, it is necessary for a user to make a note of or memorize the location or destination introduced in television programs, and then register it in the car navigation system or set it as the destination. However, with this kind of method, there may be a case in which the destination or location is not correctly registered or is forgot, which is very inconvenient.

In addition, when the EPG is utilized in a mobile device, it is necessary to set up the program guide and change channel maps every time the user travels from one region to another. Thus, it is desired to permit the mobile device to work in connection with the GPS function so that the region setup for the EPG can be performed automatically or more easily.

The present invention provides an electronic program guide as well as a navigation method and device that make use of the electronic program guide incorporated in a mobile terminal device to set locations introduced on the television (tourist spots, restaurants, hotels, etc.) as destinations in connection with a mobile navigation system to permit the destinations to be set extremely easily and accurately for navigation, and also allow the region setup of the EPG to be performed easily when the user travels from one region to another.

### Means of Solving the Problems

One aspect of the present invention provides a method of providing destination information related to a media program. The method includes the steps of a user media device receiving a media program including destination information related to the media program; the user media device extracting the destination information from the received media program; the user media device transmitting at least part of the extracted destination information to a user position identifying device for further processing by the user position identifying device; and processing at least part of the transmitted destination information by the user position identifying device.

In addition, another aspect of the present invention provides a destination information providing device for providing destination information related to a media program. The device includes: means for receiving a media program including destination information related to the media program; means for extracting the destination information from the received media program; and means for transmitting at least part of the extracted destination information to a user position identifying device for further processing by the user position identifying device.

Moreover, another aspect of the present invention provides a method of performing a region setting of a user media device that can work in connection with a user position identifying device. The method includes the steps of: the user media device obtaining current-position information identified by the user position identifying device; the user media device identifying broadcast region information corresponding to a current position, based on the obtained current-position information; and the user media device re-setting the region setting based on the identified broadcast region information when the identified broadcast region information is different from the region setting of the user media device.

Moreover, another aspect of the present invention provides a user media device that can work in connection with a user position identifying device. The device includes: means for obtaining current-position information identified by the user position identifying device; means for identifying broadcast region information corresponding to the current position based on the obtained current-position information; and means for re-setting the region setting based on the identified broadcast region information when the identified broadcast region information differs from the region setting of the user media device.

### Effect of the Invention

In this manner, in the present invention, it is possible to extract tourist spot information introduced in television programs directly from the EPG detailed information data to be transmitted directly to a navigation system as position-identifying information, so the desired tourist spot information can be reliably input into the navigation system without the trouble of manual input by the user. In addition, it is possible to use current-position information from the navigation system to easily set the broadcast region of a mobile terminal device.

### EMBODIMENTS OF THE INVENTION

Hereinafter, embodiments of the present invention will be described with reference to the attached drawings. FIG. 1-3 illustrate examples of screen shots of an EPG used in an embodiment of the present invention.

FIG. 1 shows an example of the EPG displayed on a screen display 100.

A grid is primarily used as the constitution of the EPG, which is constituted of a program display area (or program listing) 110 displaying in a matrix format with broadcasting stations and times on either of the vertical or horizontal axis, and a detailed information display area 120. This display format can be modified in any way as a user interface, with the times on the vertical axis and the names of the broadcasting stations (channels) on the horizontal axis or vice versa. Alternatively, various other formats can be displayed such that the number of broadcasting stations may be increased, the length of times displayed may be increased, or a single broadcasting station may be displayed.

These EPGs are prepared by the broadcasting stations or EPG service providers collecting data for each program to be transmitted as program data. The content is transmitted as data defined as SI (Service information) in the digital broadcasting, including SDT (Service Description Table) indicating a programming channel name of a television program, EIT (Event Information Table) indicating a program name, broadcast date, broadcast content and other program information, BIT (Broadcaster Information Table) indicating information regarding the broadcasting station, and TOT (Time Offset Table) indicating time-related information. Terminal receivers receive the data and the EPG can be formed by respective user interfaces.

In the EPG of FIG. 1, the program display area 110 includes in a horizontal column (station name column) 130 broadcasting station names and channels, such as CH-1 NNK, CH-4 HBC and CH-6 TBK, and in the vertical column (time column) 140 times after a current time 141. Program titles corresponding to respective broadcasting station names and times are displayed in appropriate cells, thus forming a matrix format program guide. Arrow keys of a remote control (not shown) or other means of operation can be used to move a cursor over the program display area 110 formed in a grid format, highlighting an individual program, so that detailed information related to that program is displayed in the detailed information display area 120.

In the program display area 110 of FIG. 1, a program 150 entitled If You Go on a Trip is highlighted at the slot of the 19:00 (7:00 pm) time and the broadcasting station of CH-4 HBC, program detail of which is displayed in the detailed information display area 120. The detailed information display area 120 is disposed in a location separate from the program display area 110, but there are no particular limitations on the location, as it may also be in the center of the program display area, or may be hidden, or it may be displayed in a “pop-up” format where it is displayed only when a program is highlighted. The detailed information display area 120 is incorporated from program outline, performers, respective stations' EPG and other information included in the event descriptors in the aforementioned EIT.

From the EPG in FIG. 1, the user can search what programs will be broadcast and on which channels and at what time they are broadcast, and the user can find out the details of the highlighted program in the detailed information display area 120.

In addition, the EPG typically displays only the current and future programs at times after the current time 141, and past programs are discarded along the elapse of time and are no longer displayed.

In addition, the screen display 100 in the embodiment of FIG. 1 can display a date/time display area 160 as well as the program currently being broadcast in a small screen (picture-in-picture; PIP) 170, displaying a program from one of the broadcasting stations at the current time or the current program highlighted on the EPG. In addition, the small screen 170 can also be used for previews of future programs or for advertising programs.

In addition, additional information display areas 180 and 190 are provided near the EPG program display area 110, and these areas can optionally be used for a ticker display of various types of information (e.g., stock prices, weather forecasts, news reports, etc.), or for commercials, advertising programs or the like.

When broadcasting stations or times cannot be displayed due to the limitations of the display, scroll buttons 210 and 220 may be pressed or the cursor may be moved left and right or up and down in a screen-scrolling mode to display broadcasting station or time slots that are not displayed, thus moving the screen of the program display area 110.

In FIG. 1, the program 150 entitled If You Go on a Trip in the 19:00˜time slot of CH-4 HBC is highlighted, and detailed information on it is displayed in the information display area 120. Further, when an enter key or any input button is pressed with the cursor in the highlighted portion 150 or the detailed information display area (primary detailed information display area) 120, more detailed information (secondary detailed information) can be displayed.

In FIG. 2, the more detailed information (secondary detailed information) is displayed in a detailed information display area 230. In this case, detailed information (secondary detailed information) for the program 150 entitled If You Go on a Trip is displayed over the entire screen, so the broadcasting station, broadcast time zone, program name, performers and program summary are displayed in addition to the “Recommended Inns and Tourist Spots” 240.

Moreover, since this program is a travel program, a travel guide, such as a travel route recommended by the program, is provided by a “Recommended Route” 250 or the like.

Provided adjacent to the secondary detailed information display area 230 are a small screen (picture-in-picture) 170, which is similar to the one in FIG. 1, along with additional information display areas 180 and 190, which are also similar to the ones in FIG. 1. They can be used for the detailed display of the current screen, various types of information in a ticker form, commercials or advertisement of programs.

According to the embodiment of FIG. 2, in order to display more detailed information, the display area is scrollable, and an arrow 270 can be used for the scroll display so that even more detail information can be displayed.

The Recommended Inns and Tourist Spots portion 240 of FIG. 2 permits inns and hotels to be selected by moving the cursor to each of the individual inns and hotels, thereby highlighting the name of the inn or hotel, their telephone number, URL, address or the like. This highlighting operation makes it possible for the Recommended Inns and Tourist Spots portion 240 to be operated in the same manner as the program display area 110 by using the same grid display and the like. It is set such that the user is allowed to obtain information related to the individual programs from the detailed information and also is allowed to highlight the desired inn or hotel so that the direction thereto is given by navigation. In the illustrated embodiment, “Hotel Yamanaka” 241 is selected and highlighted as the desired inn.

In addition, the recommended route 250 portion can also be highlighted by moving the cursor so as to be in connection with the navigation setting.

These selection operations can be done by moving the cursor and highlighting by operating a remote control or the like, but the up, down, left and right movements can also be made by touch-panel operation using on-screen directional keys 260. These cursor and highlighting movement operations can be achieved utilizing many of the previously proposed technologies.

FIG. 3 shows an example where a program 151 entitled Gourmet Man in the 18:00-time slot of the broadcasting station CH-6 TBK in FIG. 1, is highlighted as another program and its program details are displayed.

In FIG. 3, secondary detailed information 230 for the program Gourmet Man 151 is displayed on the screen of the screen display 100. The detailed information includes the restaurants introduced as “Recommended Spots” in this program displayed in a display area 280; and the name of the restaurant, its telephone number, address and the like are indicated for each of the individual restaurants.

The user is able to move the cursor and highlight restaurants to identify them. The user is able to highlight the desired one from among the group of recommended restaurant spots and link it to the navigation setting. In this embodiment, a desired restaurant 281 is selected by the user's selection in the spot 280, and the restaurant's telephone number, address and URL are displayed. However, it is not necessarily required for the telephone number, address or URL to be displayed as the detailed information, but rather, only the restaurant name may be displayed. The telephone number, address, URL and other information can be displayed by clicking the highlighted portion or by pressing the Enter (execution) key.

In FIG. 3, the detailed information related to the program includes the name, telephone number, address and URL of the desired location (a restaurant in this example), and by using the URL information, it is possible to obtain additional restaurant information in connection with the Internet. When the EPG shown in FIG. 3 is connected to the Internet, clicking an URL display 282 on the detailed information screen 230 turns the screen into an Internet browser display, in which moves to the web site of the highlighted restaurant or destination, thereby obtaining detailed information from the Internet information.

FIG. 4 shows the overall constitution of the EPG and the car navigation system according to one embodiment of the present invention. Various pieces of program information related to a television program are collected as program information by the broadcasting station or EPG service provider, and are put through an editing process and stored in a distributing EPG database 300. Regarding the program data, future data (e.g., one month's worth or one week's worth) is accumulated regularly using the current point in time as the starting point, and the program data is updated every time a program is edited or regularly at all times. These program data are edited for broadcast distribution by EPG data editing means 310 and distributed by EPG data uplink means 320 via a TV broadcast transmitting antenna 330.

The distributing EPG database 300 stores, for each program of each broadcasting station, a program title, broadcast date, description of its content and other information related to the program (program-related information). In particular, for the programs of travel, travelogue, gourmet and the like, information including the locations, landmarks, historic sites, event information, inns and restaurants introduced in that program is stored in the form of their name together with their telephone number, address and URL as EPG detailed information. In addition, in certain cases, the travel route in the program may also be stored.

There may be various methods of distributing the EPG program data depending on the infrastructure, and such a distribution is mainly performed by broadcasting via radio waves, network distribution via the Internet or telephone circuits or the like, or cable circuit distribution via cable or wired broadcasting. For digital circuits of digital broadcasting or the like, the data can be incorporated as EPG information into a broadcast stream in a data packet form, whereas in the case of analog broadcasting, the data is distributed by the inserting into several blanking interval lines in the vertical blanking interval (VBI). The data, together with the content (program audio and video), is transmitted and received via a terrestrial signal antenna in analog or digital broadcasting with terrestrial signals, and is transmitted and received via satellite in satellite broadcasting. In these broadcast distributions, the program data is distributed together with content information, whereas in the case of the Internet distribution, only the program guide data is distributed from the program guide website via the Internet, separately from the broadcast waves.

The broadcast waves transmitted from the TV broadcast transmitting antenna 330 are received by a TV reception antenna 340 connected to a TV receiver (TV tuner/EPG decoder portion) 350 in a car, mobile phone or other mobile unit 500, and are transmitted to a TV tuner 360 (see FIG. 5). In the TV tuner 360, the EPG program data is extracted from the received broadcast waves and transmitted to an EPG decoder (to be described in detail with reference to FIG. 5). In the EPG decoder, EPG program data is edited and displayed as a program guide on the screen of the display 400, examples of which are shown in FIGS. 1-3.

On the other hand, a GPS antenna 380 of the car navigation system receives position information from GPS satellites, and the GPS decoder 390 within a car navigation receiver performs comparison and processing together with map information, thereby displaying the current position and performing navigation on the display 400. In addition, the display 400 is also used as a display for television programs. The user uses a remote control 410 or an operation panel (touch panel, etc.) to operate the car navigation system, the television, and various EPG-related operations on the display 400.

When the user operates the remote control 410 or the operation panel (touch panel) to identify a location related to the program from the EPG detailed information, position information for that location is retrieved and the position information is transmitted to the GPS decoder 390. Accordingly, the position information is used as navigational position information for destination setting.

Next, the link between the EPG and the car navigation system will be described in detail.

FIG. 5 is a schematic diagram of one embodiment of a GPS decoder 390, such as a car navigation system, and an EPG decoder 350 within a television receiver in a mobile unit. Typically, the EPG is used in connection with a television or the like. The functions of the EPG includes: searching for current programs (programs in the same time slot on different channels) on the EPG screen based on the distributed EPG data; scheduled recording of a future program, searching fur preferred programs by genre, searching by keywords, searching by performers as well as obtaining information related to each program from program detailed information.

The radio waves received by the TV antenna 340 are transmitted to the TV tuner 360, where channel selection is performed, and the radio waves are transmitted to a TV signal demodulator 361 and also to EPG data extraction means 362. The TV signals are demodulated by the TV signal demodulator 361 and transmitted to the TV display 400 as display signals.

On the other hand, the EPG data extraction means 362 extracts EPG data signals. In a terrestrial signal analog broadcast system, a filter or the like is used for the extraction from the VBI signal, whereas in digital broadcast waves, the extraction is performed from packets in prescribed portions where the EPG is stored, by an identifier (Packet ID). Of the extracted EPG data, only the data required by EPG data construction means 363 to construct the EPG is stored in an EPG database server (EPG memory or other storage) 364 within the receiver. The data thus stored is retrieved every time the user requests an EPG display, when an EPG creator 365 forms a grid-style or non-grid-style or other program listing 110 (see FIG. 1), and the television program guide after the point when the user made a request is displayed on the EPG display (display) 400.

In the case of digital broadcasting, EPG data are distributed as SI from the individual broadcasting stations; however, there are also cases in which the EPG data from all the broadcasting stations are collected and distributed at once from a certain broadcasting station. However, there may be cases in which information cannot be obtained on a broadcast program while obtaining this EPG data, and therefore, it is conceivable to prepare another EPG exclusive tuner for obtaining EPG data, or prepare a plurality of tuners and use one of them.

As described previously, when viewing a travel program or gourmet food program, the user may find a destination (tourist spots, recommended locations, restaurants, hotels, etc.) introduced therein interesting, and therefore, the user may perform the operations on the EPG displayed on the display 400 to display detailed information on that program (230 in FIGS. 2 and 3), and thus highlight and identify the destination.

When a destination is identified on the EPG, its keywords (landmark/historic site, point/name of location, hotel/inn name), telephone number, address and other position-identifying information is transmitted to a position information detector 366, and such information is organized as data to be compatible with the position information detection of the car navigation system, The position-identifying information extracted from the EPG (EPG position-identifying information) is transmitted to the GPS decoder 390 to be matched with map information stored in the car navigation system.

The EPG position-identifying information, which is transmitted from the EPG to the GPS decoder, is transmitted as keyword information if the information is the name of the user's desired location in FIG. 2 or 3. If the information is a telephone number, then telephone number information with numbers is transmitted. In addition, if an address is identified, the information is transmitted as latitude and longitude information.

The GPS position information received by the GPS antenna 380 is used by a positioning device 381 in the GPS receiver to identify the latitude and longitude and measure the travel distance and other location information, so that the current position is confirmed and a current-position signal is transmitted to a position detector 382. The position detector 382 compares and matches map information obtained from a map information database 384 with current-position information from the GPS to identify the current position and make a route selection together with destination information set in destination setting means 383. Such information is displayed on the navigation information display (display) 400. When the current position, destination and route are set, the navigation system will start guiding the user (driver, etc.) along the displayed route.

In a typical car navigation system, portable phone or other GPS system, destination names (region names, building/facility names, location names, station names), addresses, telephone numbers and the like are registered or stored in advance as a map information database for the setting of destinations, and this information includes destination setting information containing latitude and longitude information, which is stored on CD-ROM, DVD-ROM, HDD or other storage media in a map information database 384 as map information.

Accordingly, the method of setting the destination may include entering a destination address or directly entering the latitude and longitude on a map to identify the destination, using a remote control or other operating control as well as entering a facility name, location name, landmark/historic site name, hotel/inn name, restaurant name, public facility name, or telephone number stored in advance in the map information database 384 to set the destination.

When the location/destination is identified by operations on the EPG, the EPG position-identifying information thus obtained is transmitted from the position information detector 366 to matching means 386 of the GPS. The matching means 386 compares, for retrieving, the EPG position-identifying information input from the EPG decoder with the map information from the map information database 384, and thus performs a keyword search or matching search.

When the EPG position-identifying information is a destination name or telephone number, a keyword or number-based keyword search or matching search is performed on the map data of the map information database 384, thus retrieving and selecting several candidate destinations. The candidate destinations thus selected are displayed on the display screen 400; and once the desired one is identified by the user, latitude and longitude information based on the destination is extracted as the destination by a position information detector 389 and is transmitted to the position detector 382. As described above, the position detector 382 compares and matches the map information obtained from the map information database 384 with the current-position information obtained from the GPS to identify the current position. Further, the position detector 382 performs route selection together with the destination information set in the navigation information construction area 383, and displays the information on the navigation information display (display) 400 via a navigation information creation area 385 so as to start navigating.

In addition, when the EPG position-identifying information is information from which the address or latitude and longitude can be identified, no keyword search or matching search will be performed, but rather the position information will be transmitted directly to the position-identifying information detector 382 of the GPS decoder, and thus the destination setting will be performed.

In addition, in the embodiment of FIG. 5, the current-position information obtained in the positioning device 381 and position detector 382 in the GPS decoder 390 is transmitted to region setting means 413 and the EPG creator 365 in the EPG decoder, thus achieving the automation of the region setting of the tuner and EPG.

The navigation information display has been described as being displayed on the same display 400 as the EPG display, but simultaneous display by means of a split-screen arrangement on the same display 400 is possible, or they may be displayed on respective individual screens by switching, or they may be displayed on separate individual displays.

The overall operations are performed by means of the remote control 410 (see FIG. 4) or touch panel on the screen, so the user performs the operations on the display 400 screen in an interactive manner. Control signals received from the remote control 410 are received by an RCU light receiver 411 and transmitted to operation control means 412. The operation control means 412 exerts microprocessor or other CPU-based control over the entire system (although not specifically illustrated), and in the case of a touch panel, receives control signals from the screen to perform operation control over the entire system.

FIG. 6 is a schematic example of a flowchart of the process up until setting the destination in the GPS decoder based on EPG position-identifying information obtained from the EPG decoder.

The EPG data thus received is demodulated by the EPG decoder and displayed on the EPG display 400 (Step S501). Next, the user highlights a cell 150 of a specific program (a travel program, etc.) from the program display area 110 and identifies the program (Step S502). Moreover, detailed information on the program in the program guide is displayed in 230 (Step S503).

Within the detailed information 230 on the program, the user highlights a desired destination and identifies the destination in the EPG detailed information 230 (Step S504). The identified destination is checked as to whether or not the destination is registered in the EPG detailed information database as position information (Step S505). When the position information (which may be one or all of the destination name, telephone number and address) of the destination spot 241 thus identified is registered in the EPG program detailed information, such information is output as EPG position information (Step S506). These operations are identified by means of database searches between the position information detector 366 and the EPG database 364 in the EPG decoder, through interactive exchanges between the user and the EPG display screen.

The EPG position information output from the position information detector 366 is transmitted to the matching means 386 in the GPS decoder 390, and is input as EPG position information (Step S507). The matching means 386 first confirms the presence of address information (latitude/longitude identifying information) (Step S508). If address information is identified in or contained in the EPG position information, that address information (latitude/longitude identifying information) is output directly to the position information detector 389, position detector 382 and destination setting means 383 as latitude/longitude identifying information (Step S509).

In Step 508, if there is no latitude/longitude identifying information existing, the name or telephone number indicating the location is used. The name and/or telephone number indicating the location is used to initiate a keyword search (Step S510) and/or telephone number search (Step S515) to the map information database stored in the map information database 384 in the GPS decoder 390.

The keyword search step (Step S511) may comprise an exact match search based on the text of the location name; however, several candidate destinations may be extracted by means of typical search methods, such as a partial match search or an ambiguous search, and then a process of selecting the destination by the user (Step S512) may be performed to narrow down the candidates. When the destination is identified by a keyword search, the latitude/longitude information belonging to the keyword is detected from the map information database 384 (Step S513), and such information is output as latitude/longitude identifying information (Step S514).

In the telephone number search step (Step S516), an exact match search based on the numerals of the telephone number is performed. If a matching number is registered in the map information database 384, the latitude/longitude information identified by that registered number is detected from the map information database 384 (Step S517), and the information is output as latitude/longitude identifying information (Step S518).

If no match is found in the keyword search step S511 or telephone number search step S516 (namely if “N” results in Step S511 or Step S516), this means that the name or telephone number in question is not registered in the map information database 384. In such a case, any further steps are canceled. In addition, a display indicating that no match was found may be shown on the display 400.

The latitude/longitude identifying information output based on the destination address, name or telephone number is used in the destination setting means 383 in the GPS decoder as latitude and longitude setting information together with the current-position information, route setting information and the like, to initiate the navigation.

Through the aforementioned process, the user is able to register the destination in the car navigation system by simply clicking a desired destination from the EPG program detailed information screen, and thus it becomes possible to start guiding instantly by the car navigation system to the desired inn, restaurant, landmark historic site or the like that was on a television program.

Next, the region setting of the EPG utilizing navigation functions will be described. Television programs have different broadcasting station names, channels and program schedules depending on respective regions. Thus, in order to construct an EPG, it is first necessary to set a region and construct a program guide schedule (channel map) that matches that region. In the case of an EPG for use in a mobile phone, car navigation system or other mobile unit, the time slots and channels of television broadcast programs change as the regions change, so region setting means must detect the region and reset the EPG schedule to one that matches that region.

FIG. 7 illustrates a flowchart for using the current-position information obtained from the GPS decoder to automate the channel or EPG region settings. When the automatic setting of the region in the EPG decoder is set to ON as directed by the user (Step S600), an automatic region setting signal is provided as output. First the current-position information (latitude/longitude information of the current position) detected by the GPS decoder 390 is retrieved from the position detector and is transmitted to the region setting means 413 in the EPG decoder (Step S602). The region setting means 413 converts the current-position information (latitude/longitude information) obtained from the GPS to appropriate current broadcast region information (Step S603). This conversion can be obtained from a predefined conversion table for broadcast service areas. This broadcast service area data map or conversion table may be stored in the EPG database or may be stored in ROM or other storage means.

A determination is made as to whether or not the current broadcast region information Obtained in Step S603 matches the currently set EPG broadcast region (Step S604). If the current broadcast region matches the set broadcast region, then no change is necessary in the channel or EPG settings. If the current broadcast region differs from the set broadcast region, a channel map for the current broadcast region thus identified is obtained from the EPG database 384 (Step S605), and the settings are changed to match the broadcast channel map of the region currently being traveled through. The region settings are transmitted to the TV tuner 360 and EPG creator 365, where channel settings are performed (Steps S606 and S607) by each of them, and then the region settings are completed.

These automatic region settings may be set to be performed always when the EPG screen is on, or the automatic region setting may be turned on periodically during travel, so that the channel region settings of the tuner and EPG always match the region being traveled through.

Next, another embodiment of the present invention will be described with reference to FIG. 8. With the spread of terrestrial digital broadcasting, television receivers are often incorporated into mobile phones and other mobile terminals, and at the same time, the environment in which an EPG can be utilized is becoming broader. In addition, it is also possible to incorporate navigation functions into mobile phones and other mobile terminals, so the utilization of navigation in mobile phones is spreading as navigation-equipped mobile phones. It is also conceivable to select the destination from EPG functions and transfer the EPG position information to a separate navigation system, and thus set the destination.

In this embodiment, even if the EPG is not installed in a car navigation system, it is possible to utilize the EPG installed in a mobile phone or mobile display or the like to guide the user to a spot introduced on a television program in connection with a navigation system.

In FIG. 8, a mobile phone or other mobile terminal 700 has TV display functions and EPG functions. When the user wishes to be guided by the navigation system to a location related to a broadcast program in the EPG in the same manner as in the previous embodiment, the user highlights a desired program in the EPG to display the detailed information for that program. In FIG. 8, one example of an EPG screen 701 is displayed on the display of a mobile phone, etc. The display shows programs of the broadcasting station (TV Asia) CH-4 at the current time and thereafter. By operating directional keys or movement keys 710 on the portable terminal, the user can move the cursor or highlighted area for each program. In FIG. 8, a cell 702 for Trip Travelogue at 10:00—is highlighted; and by clicking this or pressing the Enter button 711, a detailed information screen 703 for this program is displayed.

On the detailed information screen 703, recommended inns, restaurants, landmarks/historic sites or the like introduced in the program are displayed, or a recommended tour route may be introduced. The user may operate the directional keys or movement keys 710 to highlight the desired recommended hotel or landmark or other spot, and search for inns, restaurants, landmarks/historic sites or other spots. The detailed information is added with keywords or data, such as name, telephone number and address of each spot, that can be used to identify the location, which may or may not be displayed.

In the example of FIG. 8, several hotels and inns are introduced as program-related detailed information, and these are registered in the EPG, where “Michinoku inn” 704 is highlighted. If the user wishes to head toward that location, the user presses the Enter button 711 at the highlighted portion so that the keywords or data, which is the EPG position-identifying information identifying each of the respective locations, is transmitted and stored in a memory 805 provided in the mobile terminal device 700.

When the mobile phone or other mobile terminal has GPS functions, the position-identifying information of the destination is transferred directly to destination setting means 721 in the GPS decoder, where the keywords or data are used by the same method as described in FIGS. 5 and 6 to detect the position information (latitude/longitude information) of the destination from the navigation map database by means of keyword searches or data matching in the navigation system to set the destination. Once the destination is set, through feedback as to whether or not navigation guidance is started and upon the request by the user, position setting means 723 will confirm the current position by the GPS, and operates the setting and confirming of the route through interactive operations between the display screen and user. Thus, navigation will start once traveling starts.

In FIG. 8, when a program-related recommended spot (inn, restaurant, landmark, historic site, etc.) desired by the user and selected in the EPG is clicked with the Enter button 711, indicating that navigation is desired, the EPG position-identifying information (keyword, telephone number, map coordinates, address, postal code and other data) is temporarily stored in the memory 805 in the terminal device. The stored position-identifying information is extracted by memory card, USB (Universal Serial Bus) memory or the like and moved to a memory port 724 on the car navigation system side, and transferred to destination setting means 721.

FIG. 9 is a conceptual diagram illustrating a method of allowing the mobile terminal 700 and mobile unit 500 to work in connection when the aforementioned mobile terminal does not have internal GPS functions. The EPG program data distributed from a television program guide provider 801 via Internet or telephone circuits or other network circuits 802 is displayed as an EPG on the display of a mobile phone 803 or personal computer (PC) 804. The EPG can be used to obtain program-related position-identifying information from detailed information as described above.

In this embodiment, the EPG position-identifying information stored in the memory in the mobile terminal 700 is transferred to the car navigation system or GPS decoder via Bluetooth, infrared (IR) signals, LAN/WAN, telephone circuits or other transfer means 900, instead of the aforementioned transfer from the memory 805 via a memory card or the like. The EPG position-identifying information stored in the memory is transferred via wireless transfer means 806 from an antenna 807 of the mobile terminal. The EPG position-identifying information thus transmitted is received by a receiver 725 on the car navigation system side, and transferred to the GPS decoder 390 of the navigation system. The car navigation system side must have a memory card or USB-compatible memory slot, or must be equipped with a Bluetooth or infrared (IR) receiving terminal 725, or other suitable communication or data receiving means.

The EPG position-identifying information transmitted to the car navigation system side is transmitted to the destination setting means 721, and as described in detail with FIGS. 5 and 6, the destination is set by means of keyword search, data matching or other means in the same manner as in the GPS decoder. Once the destination setting is complete, the car navigation operation can be set as per the previous description.

The embodiments of the present invention have been described with mobile phones and car navigation systems as examples of the mobile terminals; however, the present invention is not limited to this, as the present invention may also be performed in the EPG of a PC or TV, DVD recorder or other device at home. That is, it is possible to display detailed information from the EPG of a PC, TV or DVD recorder, highlight the recommended spot position-identifying information in the detail information for the location where the user wishes to visit, store this information on a memory card and transmit the information in the memory card to a car navigation system, thereby similarly achieving the purpose.

In addition, if the PC, TV or DVD recorder are linked to a car navigation system via the Internet, LAN or the like, it is extremely easy to transmit recommended spot position-identifying information as destination-setting information for the car navigation system from a PC, TV, DVD recorder or other device via the Internet or LAN.

In addition, while the embodiments of the present invention are described in view of an electronic program guide (EPG) of television programs, it is also possible to display program-related information for digital radio and various other types of data broadcasts. Therefore, the present invention is applicable not only to television programs but also to various types of data broadcasts and media programs as similarly.

As described above, an electronic program guide and navigation system according to one embodiment of the present invention comprises: server means that provides landmarks, historic sites and other tourist spots and position information related to television programs and other media programs; a television display or other means for receiving said media programs by a user terminal processing device; means in which said user terminal processing device receives media information related to said media program, where said media information comprises at least one landmark or historic site related to the aforementioned media program; and means for transmitting position-identifying information related to at least some of those landmarks or historic sites, from said user media equipment to said user position identifying equipment, to be processed.

Moreover, a broadcast region setting device for user media equipment in a mobile unit according to one embodiment of the present invention comprises: in user media equipment that can be operated in connection with user position identifying equipment, means for obtaining current-position information from the user position identifying equipment; means for identifying broadcast region information corresponding to the current position based on the current-position information thus obtained; and means for changing a setting to identified broadcast region information when the identified broadcast region information differs from the region setting of said user media equipment.

In one embodiment of the present invention, television program data, in which television programs are converted into data, is collected by an EPG service provider or the like for programs that are broadcast by all broadcasting stations in the nation, and the data is stored in a media (EPG) data server to be transmitted together with broadcast waves by means of broadcasting or other transmission means. In addition, in a networked EPG, information is provided to each terminal receiving device via the Internet, telephone circuits or other network links. The transmitted program information may contain various types of information related to the program content, including hotels, restaurants, landmarks, historic sites and other locations that appear in the programs, as well as keywords, telephone numbers, map coordinates, street names, postal codes and other information that identifies positions. The position-identifying information may be transmitted as EPG program information via radio waves or over a network alone or together with the programs (content), and may be received by receiving apparatus on the mobile terminal.

According to one embodiment of the present invention, a mobile terminal receiving apparatus includes means for taking out information as EPG data and moreover extracting desired program position information based on user selection as keywords from said program-related information. The extracted position-identifying information is input as position-identifying information to a mobile unit positioning system that utilizes the GPS, and navigation to the destination is performed by means of the positioning device and position detection means.

As described above, according to one embodiment of the present invention, recommended spot position-identifying information, which is obtained from program detailed information on the EPG, is utilized as destination-setting information for car navigation, so that, linking with the television program, it is possible to easily set inns, restaurants, landmarks, historic sites and other recommended spots from the program, and to set navigation settings extremely simply. In addition, there is no need to write down the names, addresses, telephone numbers or other information about spots desired to visit while watching a program, and such information can be directly input to a navigation system. Therefore, the destination can be set reliably without error.

In addition, according to one embodiment of the present invention, by linking the EPG system with the navigation system in a mobile terminal device, it is possible to use the current-position information obtained from the navigation device to simply set the region for the television channels and EPG.

Moreover, by transferring position-identifying information obtained from the EPG of a home PC, TV, DVD recorder or the like to a car navigation system via a memory card or network circuit, many advantages can be attained including one where a desired television program recommended spot can be automatically set as the destination of a car navigation system.

### BRIEF DESCRIPTION OF THE DRAWINGS

FIG. 1 is a screen showing one example of an EPG according to an embodiment of the present invention.

FIG. 2 is a screen showing one example of detailed information of an EPG according to an embodiment of the present invention.

FIG. 3 is a screen showing one example of detailed information of an EPG according to an embodiment of the present invention.

FIG. 4 is a diagram showing an overall constitution of a system including EPG distribution and car navigation system.

FIG. 5 is a block diagram shoring a constitution of the EPG and car navigation system according to one embodiment of the present invention.

FIG. 6 is a flowchart up until setting of a destination based on EPG information.

FIG. 7 is a flowchart showing EPG region setting based on GPS information.

FIG. 8 is a block diagram showing another embodiment of the present invention.

FIG. 9 is a conceptual diagram showing an overall constitution of another embodiment of the present invention.

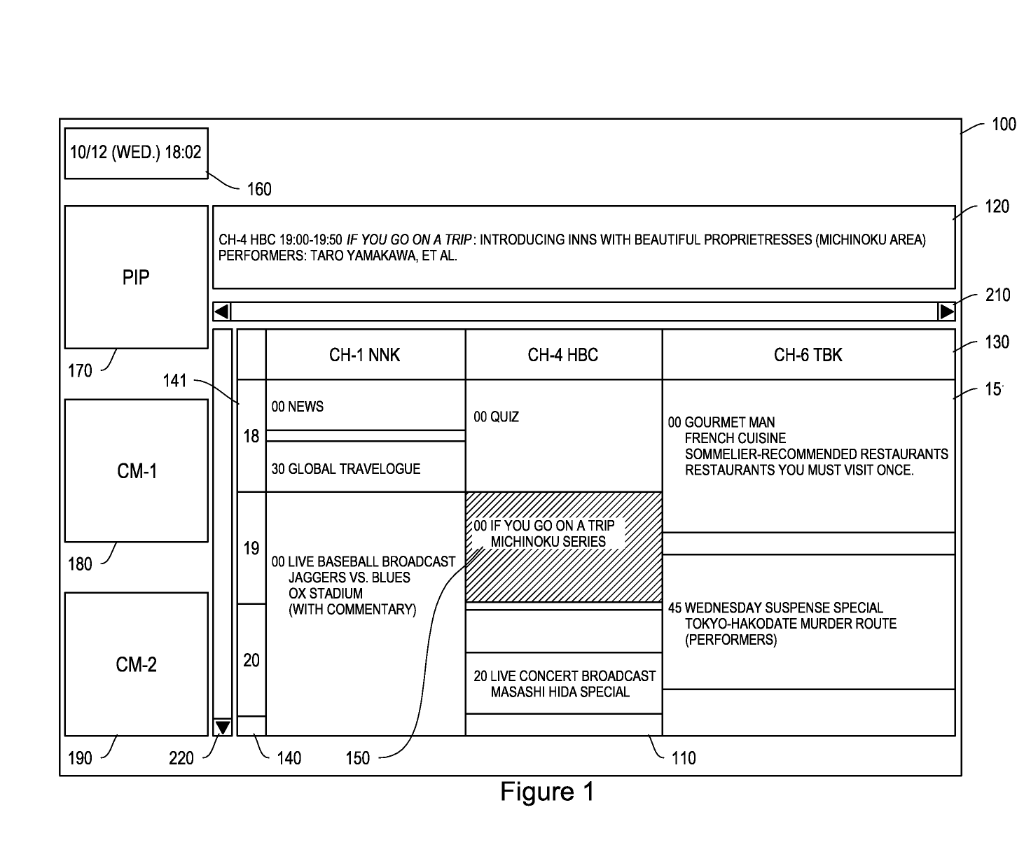

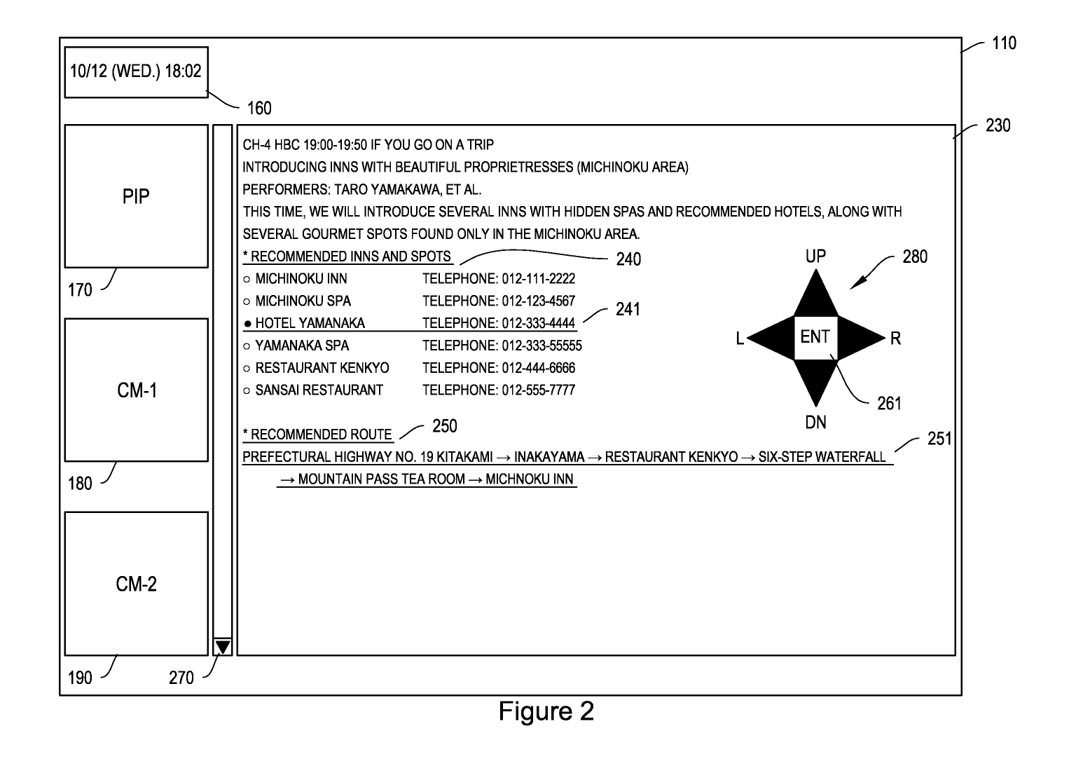

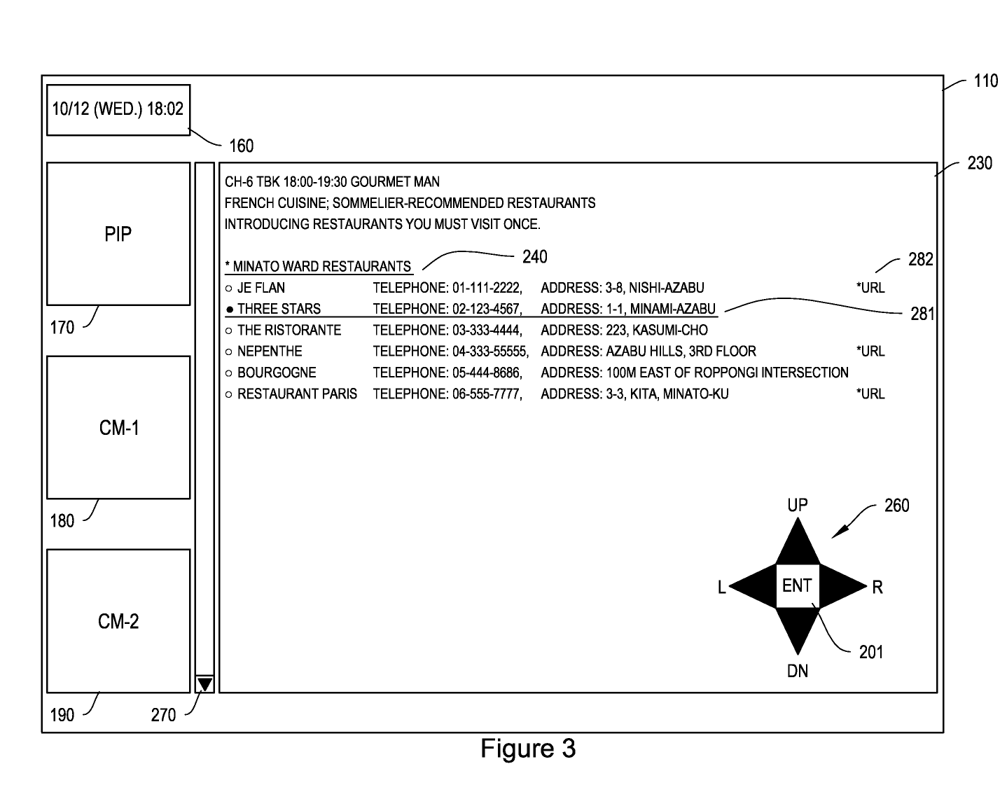

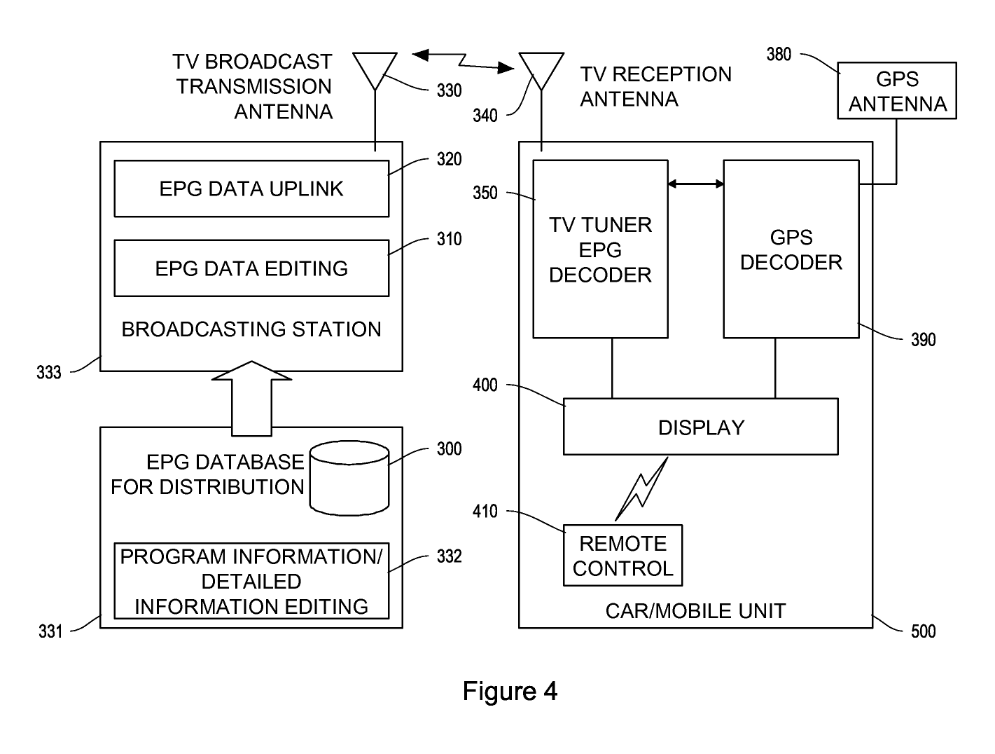

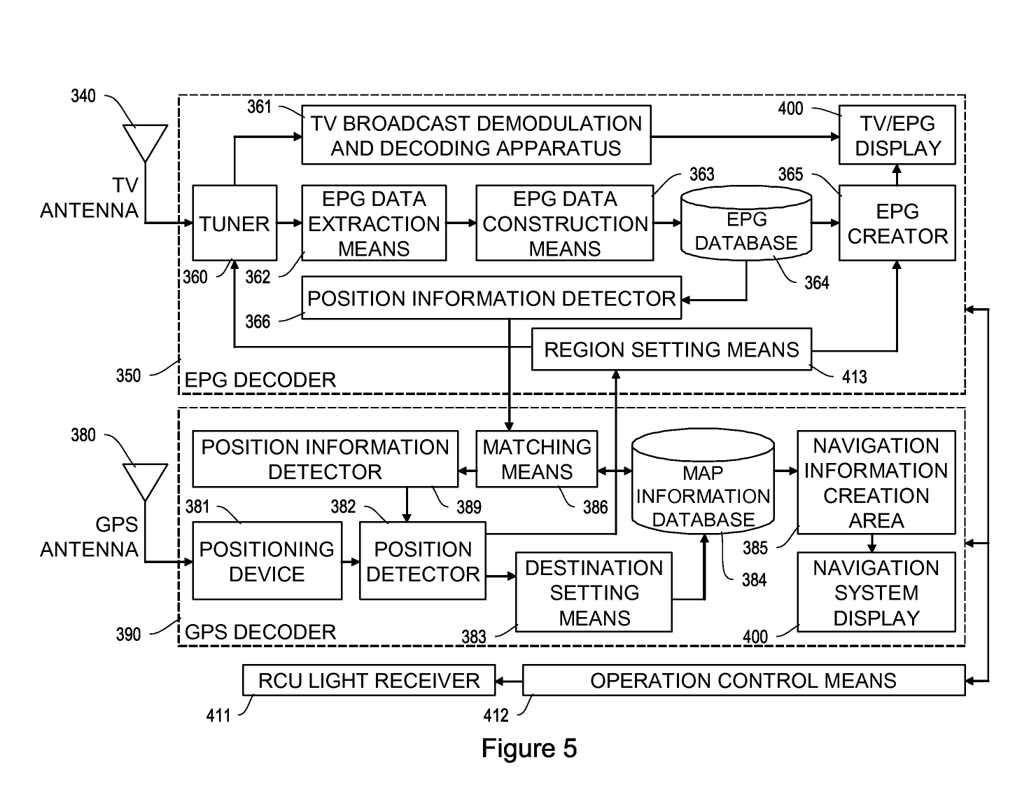

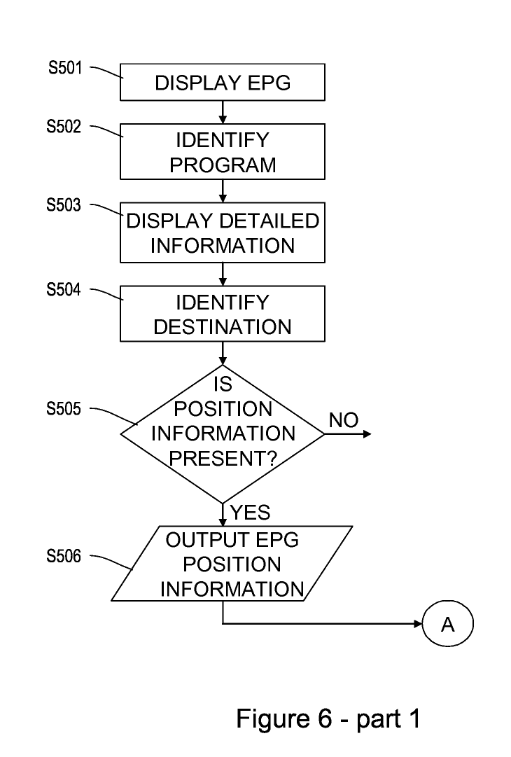

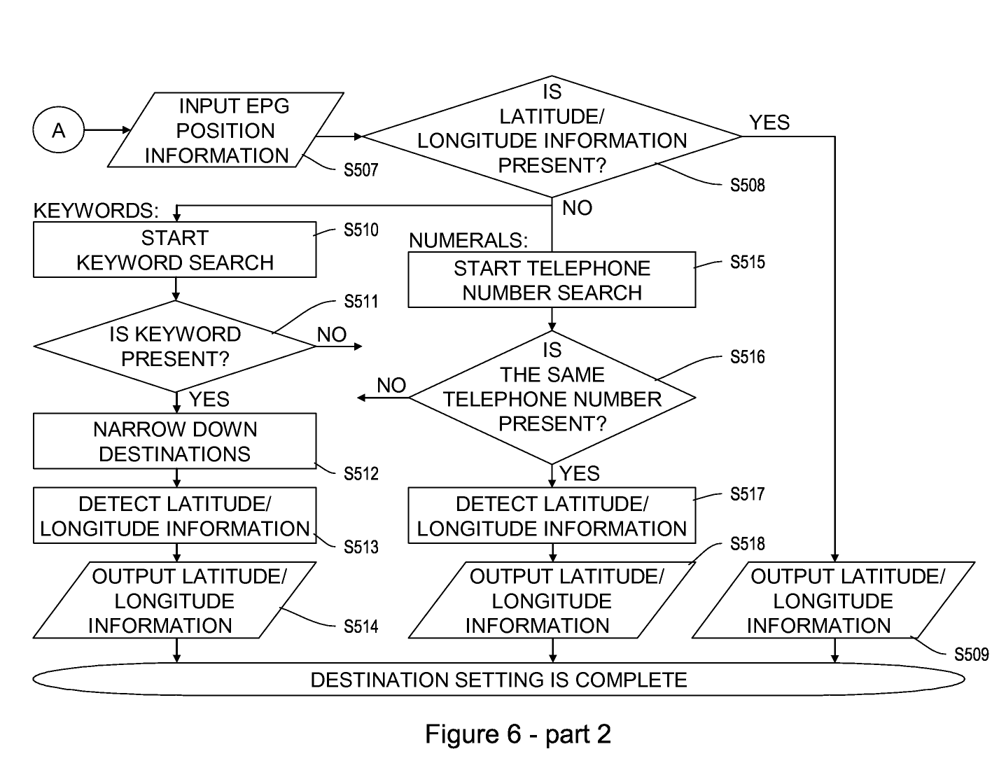

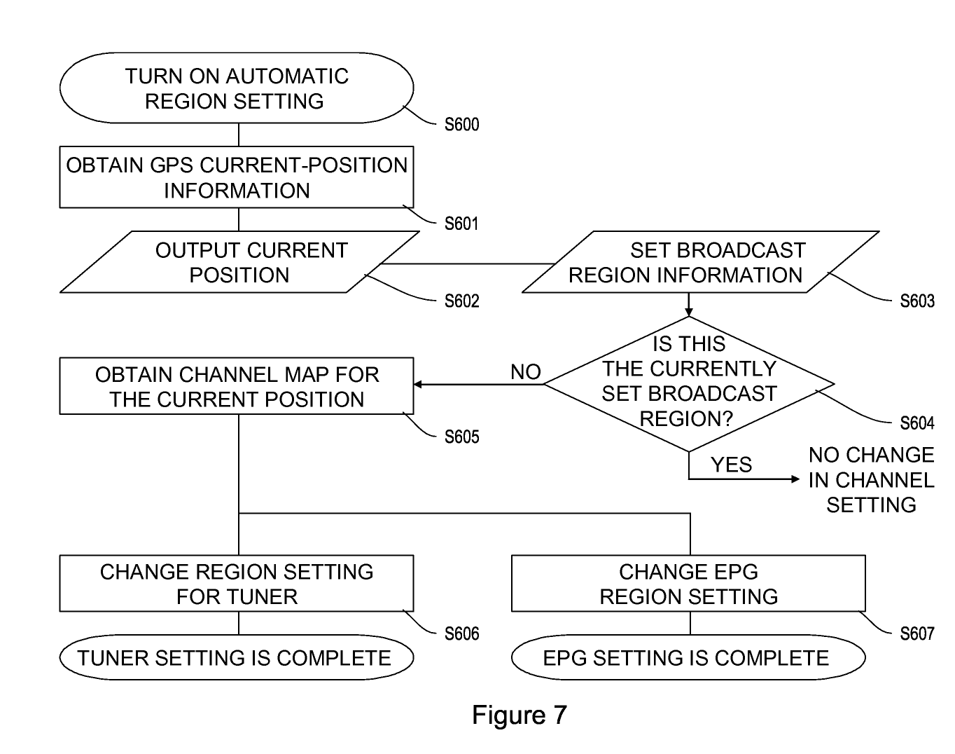

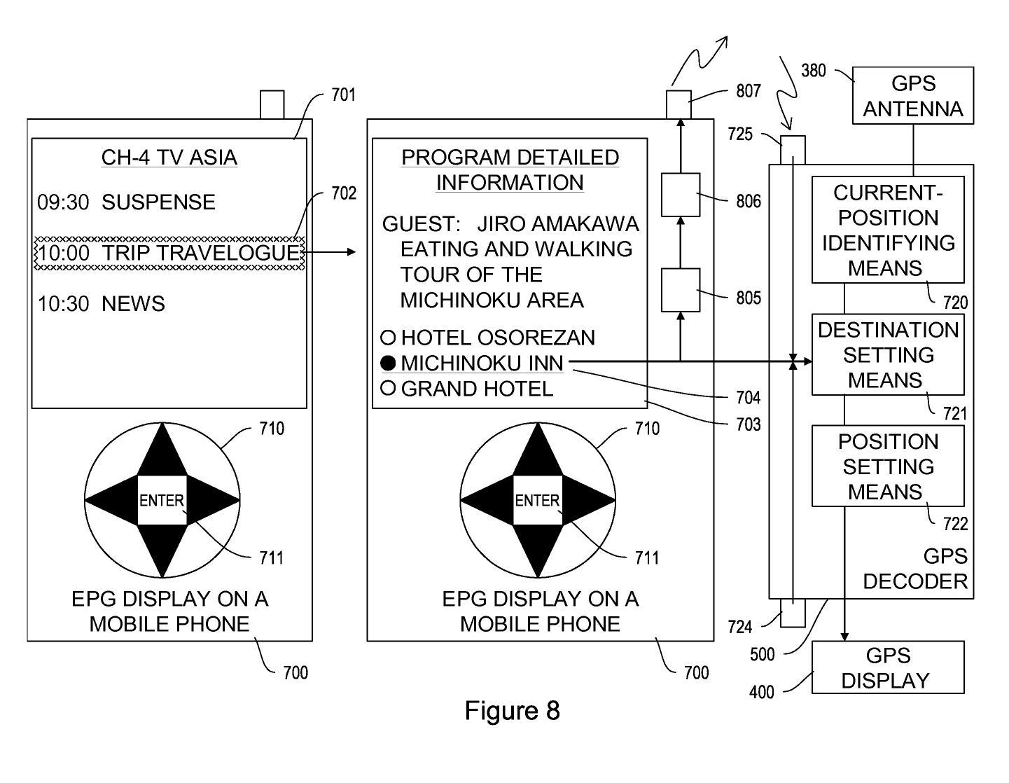

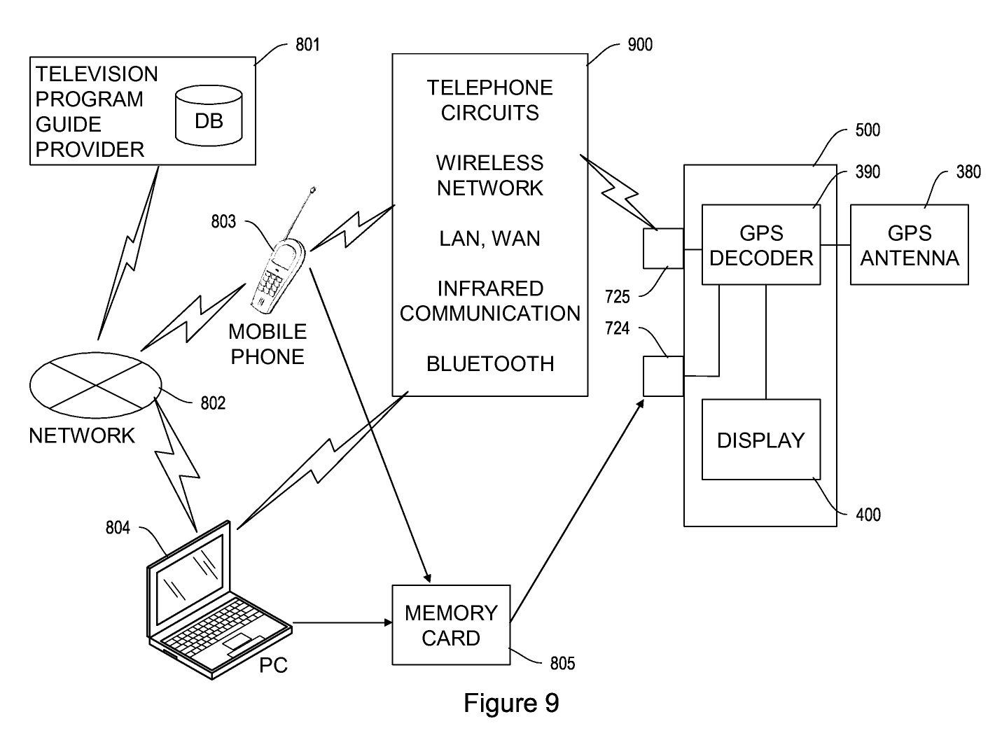

### DESCRIPTION OF REFERENCE NUMERALS

100 screen display
110 program display area
120 detailed information display area
130 station name column
140 time column
150 cell
160 date/time display area
230 secondary detailed information display area
260 directional keys
270 enter key
300 EPG database for distribution
310 EPG data editing
320 EPG data uplink
350 EPG decoder
390 GPS decoder
400 display
410 remote control
500 mobile unit
364 EPG database server
384 map information database
366 position information detector
386 matching means
383 destination setting means

1. A method of providing destination information related to a media program, characterized in that the method comprises the steps of:
a user media device receiving a media program including destination information related to the media program;
the user media device extracting the destination information from the received media program;
the user media device transmitting at least part of the extracted destination information to a user position identifying device for further processing by the user position identifying device; and
the user position identifying device processing at least part of the transmitted destination information.

2. The method according to claim 1, characterized in that the position information includes one or more of a keyword, a landmark, a telephone number, map coordinates, an address, a street name, an intersection name and a postal code.

3. The method according to claim 1, characterized in that the method further comprises the steps of:
the user media device displaying media information related to the media program on a display means; and
the user media device allowing a user to select the displayed media information,
wherein the user media device transfers the destination information related to the selected media information to the user position identifying device in response to the selection by the user.

4. The method according to claim 1, characterized in that the user media device is a mobile communication device.

5. The method according to claim 1, characterized in that the user media device includes interactive program guide media information for receiving the media program.

6. The method according to claim 1, characterized in that the user position identifying device is a navigation device.

7. The method according to claim 1, characterized in that the at least part of the destination information transmitted from the user media device is transmitted to the user position identifying device via one of a memory device, a wired connection, a wireless connection and a network connection.

8. A destination information providing device for providing destination information related to a media program, characterized in that the device comprises:
means for receiving a media program including destination information related to the media program;
means for extracting the destination information from the received media program; and
means for transmitting at least part of the extracted destination information to a user position identifying device for further processing by the user position identifying device.

9. A method of performing a region setting of a user media device that can work in connection with a user position identifying device, characterized in that the method comprises the steps of:
the user media device obtaining current-position information identified by the user position identifying device;
the user media device identifying broadcast region information corresponding to a current position, based on the obtained current-position information; and
the user media device re-setting the region setting based on the identified broadcast region information when the identified broadcast region information is different from the region setting of the user media device.

10. The method according to claim 9, characterized in that the user media device includes a media program guide, and the identified broadcast region information is used for the region setting of the media program guide.

11. The method according to claim 9, characterized in that the user media device includes a mobile television receiver, and the identified broadcast region information is used for the region setting of the mobile television receiver.

12. A user media device that can work in connection with a user position identifying device, characterized in that the device comprises:
means for obtaining current-position information identified by the user position identifying device;
means for identifying broadcast region information corresponding to the current position based on the obtained current-position information; and
means for re-setting the region setting based on the identified broadcast region information when the identified broadcast region information is different from the region setting of the user media device.

13. The device according to claim 12, characterized in that the user media device includes a media program guide, and the identified broadcast region information is used for the region setting of the media program guide.

14. The device according to claim 12, characterized in that the user media device includes a mobile television receiver, and the identified broadcast region information is used for the region setting of the mobile television receiver.
